(19) United States
(12) Patent Application Publication
(10) Pub. No.: US 2021/0086761 A1
(43) Pub. Date: Mar. 25, 2021

(54) WAKING-UP PARKED VEHICLES FOR PERFORMING A COOPERATIVE PARKING MANEUVER WITH V2X COMMUNICATION

(71) Applicants: VOLKSWAGEN AKTIENGESELLSCHAFT, WOLFSBURG (DE); AUDI AG, INGOLSTADT (DE)

(72) Inventors: Ahmad EL ASSAAD, Wolfsburg (DE); Thorsten HEHN, Ingolstadt (DE)

(21) Appl. No.: 17/026,596

(22) Filed: Sep. 21, 2020

(30) Foreign Application Priority Data
Sep. 20, 2019 (EP) 19198678.5

(51) Int. Cl. B60W 30/06; B60R 16/023; H04W 4/44; H04W 52/28

(52) U.S. Cl. CPC B60W 30/06; H04W 52/287; H04W 4/44; B60R 16/0231

(57) ABSTRACT

A method for starting a parking transportation vehicle located on a parking position in park mode to perform a cooperative parking maneuver. The parking transportation vehicle is equipped with an on-board communication module capable of performing mobile radio communication. The method includes registering wake-up information with a message exchange in a parking backend server in response to the parking transportation vehicle being put in park mode. The wake-up information includes information about communication resources to be used for sending a wake-up message to the parking transportation vehicle and for identifying the wake-up message. The method also includes listening to the registered communication resources during park mode, leaving park mode and switching to normal mode, and sending a starting request message to the parking backend server, receiving a starting message from the parking backend server, and starting the engine for performing the cooperative parking maneuver.

### PRIORITY CLAIM

This patent application claims priority to European Patent Application No. 19198678.5, filed 20 Sep. 2019, the disclosure of which is incorporated herein by reference in its entirety.

### SUMMARY

Illustrative embodiments relate to a method for starting a parking transportation vehicle located on a parking position in park mode to perform a cooperative parking maneuver. Illustrative embodiments further relate to a method for requesting a cooperative parking maneuver by an arriving transportation vehicle which arrives at a location of a parking transportation vehicle intending to perform a cooperative parking maneuver with the parking transportation vehicle. Illustrative embodiments also relate to corresponding computer programs.

### BRIEF DESCRIPTION OF THE DRAWINGS

Disclosed embodiments will become apparent from the following description and the appended claims in combination with the drawings.

FIG. 1 illustrates a typical parking scenario in cities;

FIG. 2 illustrates how the inconvenient parking situation is improved with a cooperative parking maneuver;

FIG. 3 illustrates the resulting parking gap filling after performance of the cooperative parking maneuver;

FIG. 4 illustrates the principle architecture of a V2V and V2X communication system;

FIG. 5 shows a block diagram of aboard electronics system of a transportation vehicle;

FIG. 6 shows a first stage message exchange diagram for negotiating communication resources for a cooperative parking situation;

FIG. 7 shows the location and structure of a resource block in a multi-carrier transmission method;

FIG. 8 shows the structure of a transmission frame according to the LTE standard;

FIG. 9 shows a second stage message exchange diagram for requesting negotiated communication resource information for preparing a cooperative parking operation;

FIG. 10 shows a third stage message exchange diagram for starting a cooperative parking situation; and

FIG. 11 shows a flow chart of a computer program which is executed during the phase of listening to wake-up messages.

### DETAILED DESCRIPTION

In the following years, more and more transportation vehicles will be able to handle an increasing number of situations automatically, without a direct intervention of the driver. To handle these situations, the automatic transportation vehicles will be equipped with an increasingly high number of sensors, like ultra-sonic sensors, laser scanners, radar sensors, lidar sensors,

cameras, etc. These sensors are used to scan the environment of the transportation vehicle and make this information available to algorithms responsible for moving the autonomous or semiautonomous transportation vehicle safely inside in its environment. One possible use case for autonomous or semiautonomous driving are scenarios with cooperative parking maneuvers.

Some drivers don't respect the subdivision of parking lots or parking lanes in parking spaces. This may be due to an incapability of parking the car properly or due to an absence of a proper labelling of parking spaces with separation marks. This often leads to gaps in parking lots or parking lanes which cannot be used by other cars arriving at the parking space.

A method for cooperative parking is known, for example, from DE 10 2015 211 732 A1. In the process, a transportation vehicle that is itself in search of a parking space observes a transportation vehicle in front and recognizes the parking intention of the preceding transportation vehicle. By timely stopping it supports the parking process of the transportation vehicle ahead.

In US 2015 0 039 173 A1 different cooperative parking scenarios are described in detail. This includes that the parking control management system has permission to activate or initiate car movement among the parked cars, to move improperly parked cars to a position inside the parking lines of a parking space.

From DE 10 2010 052 099 A1 it is known a system that has a transportation vehicle external communication unit that is formed to transmit a prompt signal and a functional requirement at a transportation vehicle internal controlling unit. The transportation vehicle internal controlling unit is provided for authentication of the prompt signal. A controlling data is received for executing a requested function during positive authentication according to the functional requirement.

From DE 10 2014 010 002 A1 it is known an apparatus for controlling a device of a transportation vehicle including a communication unit configured to shift the device of the transportation vehicle from an idle mode to an active mode by sending a first wireless signal. The apparatus is configured to specify a frequency and/or a channel for transmitting and/or receiving the first wireless signal in the active mode and to control the device so that the device is only shifted from the idle mode to the active mode when the first wireless signal is received at the specified frequency and/or the specified channel.

From U.S. Pat. No. 7,498,954 an arrangement and a method and a service that allows drivers wanting to parallel park to request unoccupied surrounding transportation vehicles to move forward and/or backwards to increase the space available to the requesting transportation vehicle and then subsequently allows the surrounding transportation vehicles to return to their original position. In at least one disclosed embodiment, a cooperative parking system comprises a switch to initiate the cooperative parking system and a transmitter connected to the switch either contained within a hand-held programmable device or within the parking transportation vehicle.

These solutions encounter the problem that the channel or frequency to which a transportation vehicle needs to listen will be permanently scanned when the transportation vehicle is in park mode. The reservation of frequencies or channels is made by the transportation vehicles themselves or by the handheld device with which the transportation vehicle could be switched from park mode to active mode.

Disclosed embodiments provide a more energy efficient solution for waking-up parked transportation vehicles to perform a cooperative parking maneuver on request of an arriving transportation vehicle searching for a parking space.

Disclosed embodiments increase reliability of the wake-up operation for greater parking areas where plenty of cars are parking.

This is achieved by a method for starting a parking transportation vehicle located on a parking position in park mode to perform a cooperative parking maneuver, a method for requesting a cooperative parking maneuver by an arriving transportation vehicle which arrives at a location of a parking transportation vehicle, and corresponding computer programs.

At least one exemplary embodiment relates to a method for starting a parking transportation vehicle located on a parking position in park mode to perform a cooperative parking maneuver, the parking transportation vehicle being equipped with an on-board communication module comprising registering with a message exchange wake-up information in a parking backend server once the parking transportation vehicle is put in park mode. The wake-up information is comprising information about communication resources to be used for sending a wake-up message to the parking transportation vehicle and for identifying the wake-up message. The solution further comprises listening to the registered communication resources during park mode. When receiving the wake-up message from an arriving transportation vehicle, the method further comprises leaving park mode and switching to normal mode, sending a starting request message to the parking backend server, receiving a starting message from the parking backend server, and starting the engine or motor for performing the cooperative parking maneuver. The idea to engage a parking backend server for assigning wake-up information to the parking transportation vehicles provides for a greater reliability in performing cooperative driving maneuvers with parked transportation vehicles.

In an exemplary embodiment the solution comprises that operation of listening to the registered communication resources during park mode comprises sporadically listening to the registered communication resources during park mode. This allows for a further reduction in energy consumption for the parked transportation vehicle. If e.g., the parked transportation vehicle listens to the corresponding communication resources only one time in a second instead of every ms, there is a subjective reduction in energy consumption for the scanning operation, thereby saving battery life in the parked transportation vehicle.

In another exemplary embodiment, the operation of sporadically listening to the registered communication resources during park mode comprises to listen to the registered communication resources periodically in an interval which is longer than an interval with which the arriving transportation vehicle should repeat its wake-up message. This makes sure, that the wake-up message will eventually be received in a listening operation of a parked transportation vehicle.

It is further beneficial when the registered wake-up information comprises an authentication preamble which needs to be used in the wake-up message which is sent by the arriving transportation vehicle to identify the wake-up message. This increases the security of the wake-up communication. This way it not easily possible for an intruder to fake the wake-up message and start a driving maneuver unauthorized.

When the wake-up communication is performed with a mobile radio communication system such as LTE or 5G it is of benefit if the registered wake-up information further comprises the resource pool configuration to which the parking transportation vehicle should listen in park mode. A resource pool can be reduced to just a few resource blocks which will be transferred on a frequency bandwidth of only 180 kHz such that in a 20 MHz channel plenty of communication resource reservations are possible to serve a high number of transportation vehicles in large parking areas without having interfering individual wake-up messages. In this form the wake-up procedure can contribute to less power consumption on the parking transportation vehicle on the direct-link between transportation vehicles, since the parking transportation vehicle only needs to listen to the agreed wake up frequencies.

In another exemplary embodiment, the operation of checking the authentication preamble is executed as part of the wake-up process before waking up the whole board electronics of the transportation vehicle and wherein the waking up the board electronic transportation vehicle architecture is suppressed if the operation of the preamble check results in the finding that the authentication preamble does not match the registered authentication preamble. This also contributes much to an energy efficient solution for the wake-up process since powering-up the whole board electronics is energy consuming.

Moreover, the security of cooperative parking maneuvers could be increased further with a start key which the parking backend server should send in the starting message, to start the engine or motor for performing the cooperative parking maneuver.

It is of benefit if the messages for registering wake-up information and the starting request message are sent in a format of an LTE or 5G Uu-link communication message and wherein the wake-up message is sent in a format of an LTE or 5G direct-link communication message. The direct-link communication message is now called PC5-link in the 5G communication system and was formerly called sidelink communication message in the LTE communication system. These communications are direct communications between transportation vehicle and parking backend server if the parking backend server is positioned at the place of a base station.

The disclosure also relates to a computer program comprising instructions, which, when executed by a computer, causes the computer to perform the operations of the described method for starting a parking transportation vehicle located on a parking position in park mode to perform a cooperative parking maneuver. The computer program may, for example, be provided for download or stored on a computer-readable storage medium.

Another exemplary embodiment comprises a method for requesting a cooperative parking maneuver by an arriving transportation vehicle which arrives at a location of a parking transportation vehicle intending to perform the cooperative parking maneuver with the parking transportation vehicle. Here, it is beneficial if the method comprises sending a cooperative parking intention message to a parking backend server comprising at least the estimated position of the parking transportation vehicle and a request for wake-up information for the parking transportation vehicle. This provides for the greater reliability in assigning communication resources to the individual parking transportation vehicles.

It is also beneficial if the cooperative parking intention message further comprises the position of the arriving transportation vehicle and whereby the estimated position of the parking transportation vehicle is formatted as a position relative to the position of the arriving transportation vehicle. This makes it possible to estimate the position of the parking transportation vehicle with greater accuracy, since the surroundings observation sensors of the arriving transportation vehicle can be used to increase reliability.

In another exemplary embodiment, the arriving transportation vehicle is receiving the requested wake-up information from the parking backend server in one or more response message to the cooperative parking intention message, the response message comprising an authentication preamble which needs to be used in a wake-up message which is sent by the arriving transportation vehicle to identify the wake-up message. This increases security of the wake-up operation.

It is likewise beneficial if the one or more response message further comprises the resource pool configuration to be used for sending the wake-up message to the parking transportation vehicle to which the parking transportation vehicle is listening in park mode. As explained before this greatly increases diversification of the wake-up message assignments for larger parking areas thereby eliminating the risk of interferences due to a double assignment of the same communication resources to nearby transportation vehicles.

Also it is beneficial if the arriving transportation vehicle is repeatedly sending the wake-up message to the parking transportation vehicle after having received the requested wake-up information from the parking backend server in one or more response messages. This makes sure that the wake-up message will be received in one listening period, even though the interval for two succeeding listening periods is longer than the repetition interval for sending wake-up messages.

Again, it is also beneficial that the cooperative parking intention message and the one or more response message to the cooperative parking intention message, are sent in a format of an LTE or 5G Uu-link communication message and wherein the wake-up message is sent in a format of an LTE or 5G direct-link communication message.

The disclosure further relates to a computer program comprising instructions, which, when executed by a computer, cause the computer to perform the operations of the described method for requesting a cooperative parking maneuver by an arriving transportation vehicle which arrives at a location of a parking transportation vehicle intending to perform the cooperative parking maneuver with the parking transportation vehicle.

For a better understanding of the principles of the present disclosure, exemplary embodiments are explained in more detail below with reference to the figures. Of course, the disclosure is not limited to those disclosed embodiments. It is to be understood that many other possible modifications and variations can be made without departing from the scope of the present disclosure as defined by the appended claims.

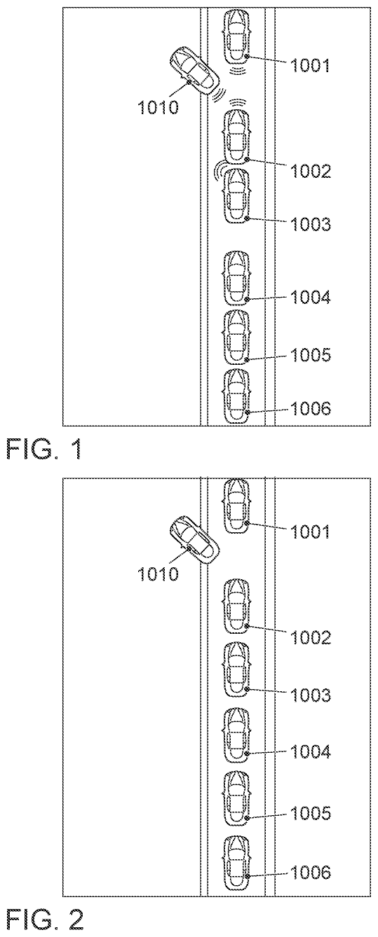

The typical use case of the disclosure is a problem with parking of a transportation vehicle on a road in a city where not enough parking space is available. The transportation vehicles need to park close to each other such that the parking space will be utilized completely. Now, FIG. 1 shows a situation with which drivers are encountered pretty often. The same problem may occur even with transportation vehicles equipped with autonomous driving capability. The transportation vehicles 1001 to 1006 all park at the side of the road one after the other. Reference number 1010 denotes an arriving transportation vehicle desiring to park in this area, too. It is considered, that all transportation vehicles 1001 to 1006 plus 1010 are equipped with autonomous driving capability. This also means, that they are also equipped with surroundings observation method or mechanism which will be described more in detail later on. With these surroundings observation method or mechanism the transportation vehicle 1010 when arriving will discover, that there is a gap between transportation vehicle 1001 and transportation vehicle 1002 where it might be possible to park. There is however the problem that there is not enough space to drive into the gap autonomously due to the fact that the driver of the autonomous transportation vehicle 1003 has improperly parked his transportation vehicle. When transportation vehicle 1010 was arriving it was able to learn that between transportation vehicle 1003 and 1004 there is somewhat more space available than needed for departing. Arriving transportation vehicle 1010 therefore concludes that it will be able to park in the gap between transportation vehicles 1001 and 1002, if transportation vehicle 1003 drives back closer to transportation vehicle 1004 and transportation vehicle 1002 does the same, thereby increasing the gap between transportation vehicle 1001 and 1002. Since transportation vehicles 1001 and 1002 are parking, they need to be activated to perform the cooperated parking maneuver requested by arriving transportation vehicle 1010. The disclosure deals primarily with an energy efficient solution for activating the transportation vehicle parking at the road side to perform the cooperative parking maneuver.

FIG. 2 shows the moment when transportation vehicles 1002 and 1003 have driven back to fill the gap between 1003 and 1004. Transportation vehicle 1010 is then able to enter the gap between transportation vehicle 1001 and 1002 properly.

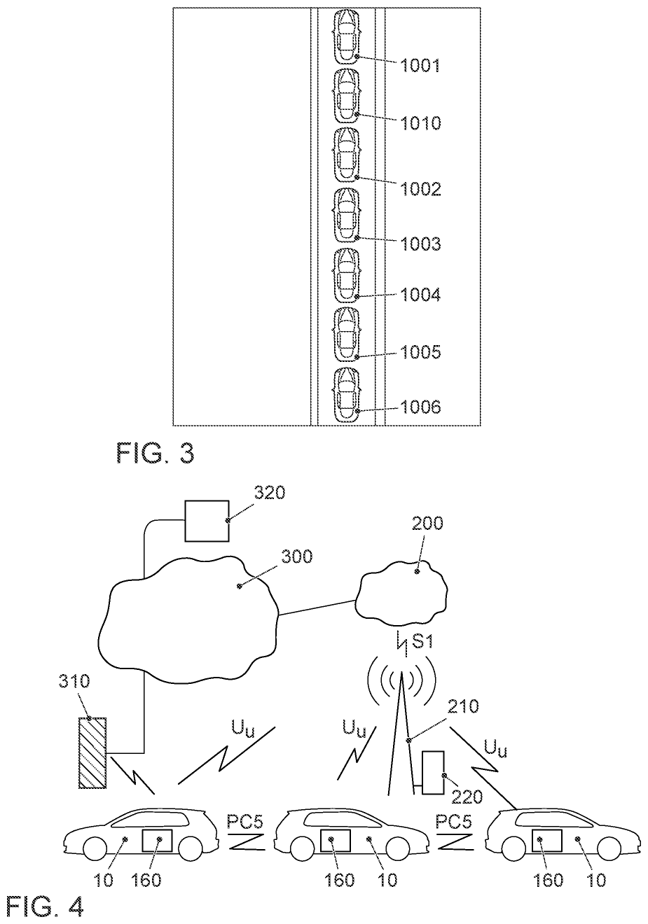

FIG. 3 finally depicts the final state of the cooperative parking maneuver when transportation vehicle 1010 has reached the parking position in the gap between transportation vehicles 1001 and 1002.

FIG. 4 shows the system architecture for the proposal. Reference number 10 denotes a user device. The depicted user device is exemplified as a transportation vehicle and, in particular, it is a car. In other examples it may be differently exemplified, e.g., a smart phone, a smart watch, a tablet computer, notebook or laptop computer or the like. Shown is a passenger car. If exemplified with a transportation vehicle, it may be any type of a transportation vehicle. Examples of other types of vehicles are: buses, motorcycles, commercial vehicles, in particular, trucks, agricultural machinery, construction machinery, rail vehicles, etc. The use of the disclosed embodiments would be generally in land vehicles, rail vehicles, watercrafts and aircrafts possible. The transportation vehicle 10 is equipped with an on-board connectivity module 160 including corresponding antenna such that the transportation vehicle 10 can participate in any form of a mobile communication service. FIG. 1 illustrates that transportation vehicle 10 may transmit and receive signals to and from a base station 210 of a mobile communication service provider.

Such base station 210 may be an eNodeB base station of an LTE (Long Term Evolution) mobile communication service provider or a gNB base station of a 5G mobile communication provider. The base station 210 and the corresponding equipment is part of a mobile communication network with a plurality of network cells where each cell is served by one base station 210.

The base station 210 in FIG. 4 is positioned close to a main road on which the transportation vehicle 10 is driving. Of course, other transportation vehicles may also drive on the road. In the terminology of LTE, a mobile terminal corresponds to a user equipment UE, which allows a user to access network services, connecting to the UTRAN or Evolved-UTRAN via the Uu radio interface. Typically, such user equipment corresponds to a smart phone. Of course, mobile terminals are also used in the transportation vehicles 10. The cars 10 are equipped with the on-board communication module OBU 160. This OBU corresponds to an LTE or any other communication module with which the transportation vehicle 10 can receive mobile data in downstream direction and can send such data in upstream or in direct device-to-device direction over the Uu-interface. Modern transportation vehicles are also equipped with vehicle-to vehicle communication capability V2V. The interface which is designed for this purpose is called PC5-interface. The on-board communication module 160 is also equipped with PC5-interface capability.

In terms of the LTE mobile communication system, the Evolved UMTS Terrestrial Radio Access Network E-UTRAN of LTE consists of a plurality of eNodeBs, providing the E-UTRA user plane (PDCP/RLC/MAC/PHY) and control plane (RRC) protocol terminations towards the UE. The eNodeBs are interconnected with each other by the so-called X2 interface. The eNodeBs are also connected by the so-called S1 interface to the EPC (Evolved Packet Core) 200, more specifically to the MME (Mobility Management Entity) by the S1-MME and to the Serving Gateway (S-GW) by the S1-U interface.

From this general architecture FIG. 4 shows that eNodeB 210 is connected to the EPC 200 via the S1 interface and that EPC 200 is connected to the Internet 300. The backend server 320 to which the transportation vehicles 10 send messages to and receive messages from is also connected to the Internet 300. In the field of cooperative and autonomous driving the backend server 320 typically is located in a traffic control center. The S1 interface may be reduced to practice with wireless communication technology such as with the help of microwave radio communication by directional antennas or wired communication technology based on fiber cables. Finally, an infrastructure network component is also shown. This may be exemplified by a road-side unit RSU 310. For the ease of implementation, it is considered that all components have assigned an Internet address, typically as an IPv6 address, such that the packets transporting messages between the components can be routed correspondingly.

The various interfaces of the LTE network architecture are standardized. It is particularly referred to the various LTE specifications, which are publicly available for the sake of sufficiently disclosing further implementation details.

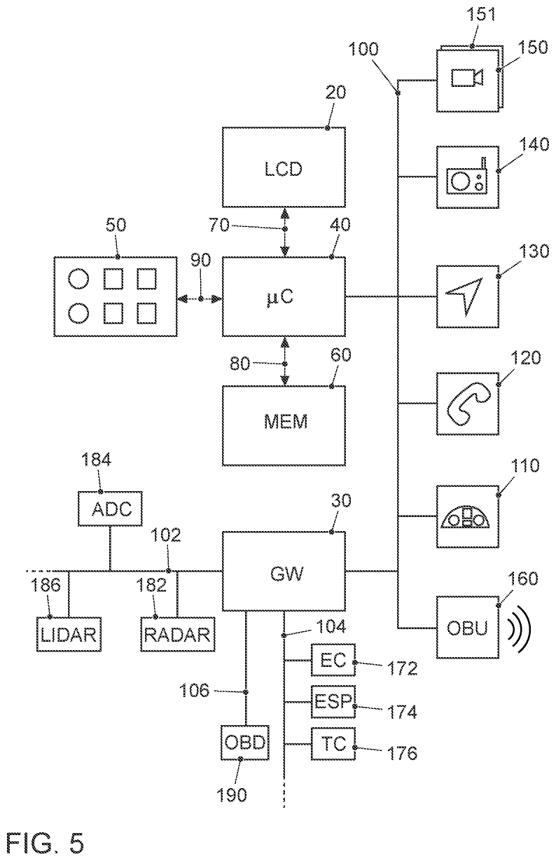

FIG. 5 shows schematically a block diagram of the transportation vehicle's 10 board electronics system. Part of the board electronics system is an infotainment system which comprises: the touch-sensitive display unit 20, a computing device 40, an input unit 50, and a memory 60. The display unit 20 includes both a display area for displaying variable graphical information and an operator interface (touch-sensitive layer) arranged above the display area) for inputting commands by a user.

The memory device 60 is connected to the computing device 40 via a further data line 80. In the memory 60, a pictogram directory and/or symbol directory is deposited with the pictograms and/or symbols for possible overlays of additional information.

The other parts of the infotainment system such as camera 150, radio 140, navigation device 130, telephone 120 and instrument cluster 110 are connected via the data bus 100 with the computing device 40. As data bus 100 the high-speed option of the CAN bus according to ISO standard 11898-2 may be taken into consideration. Alternatively, for example, the use of an Ethernet-based bus system such as IEEE 802.03cg is another example. Bus systems in which the data transmission via optical fibers happens are also usable. Examples are the MOST Bus (Media Oriented System Transport) or the D2B Bus (Domestic Digital Bus). For inbound and outbound wireless communication, the transportation vehicle 10 is equipped with a communication module 160. It can be used for mobile communication, e.g., mobile communication according to the LTE standard, according to Long Term Evolution.

Reference numeral 172 denotes an engine control unit. The reference numeral 174 corresponds to an ESC control unit corresponding to electronic stability control and the reference numeral 176 denotes a transmission control unit. The networking of such control units, all of which are allocated to the category of the drive train, typically occurs with the CAN bus system (controller area network) 104. Since various sensors are installed in the transportation vehicle and these are no longer only connected to individual control units, such sensor data are also distributed via the bus system 104 to the individual control devices.

However, the modern transportation vehicle can also have further components such as further surroundings scanning sensors like a LIDAR (Light Detection and Ranging) sensor 186 or RADAR (Radio Detection and Ranging) sensor 182 and more video cameras 151, e.g., as a front camera, rear camera or side camera. Such sensors are used more and more in transportation vehicles for surroundings observation. Further control devices, such as an automatic driving control unit ADC 184 or a parking assistance control device (not shown), etc., may be provided in the transportation vehicle. It is noted that the parking assistance functionality is included in the automatic driving control unit ADC 184. There may be other systems in the transportation vehicle, too such as UWB transceivers for inter-vehicle distance measurement (not shown). The UWB transceivers may typically be used for a short distance observation, e.g., 3 to 10 m. The RADAR and LIDAR sensors 182, 186 could be used for scanning a range up to 150 m or 250 m and the cameras 150, 151 cover a range from 30 to 120 m. The components 182 to 186 are connected to another communication bus 102. The Ethernet-Bus may be a choice for this communication bus 102 due to its higher bandwidth for data transport. One Ethernet-Bus adapted to the special needs of car communication is standardized in the IEEE 802.1Q specification. Moreover, a lot of information for surroundings observation may be received via V2V communication from other road participants. Particularly for those road participants not being in line of sight LOS to the observing transportation vehicle it is very beneficial to receive the information about their position and motion via V2V communication.

Reference number 190 denotes an on-board diagnosis interface.

For the purpose of transmitting the vehicle-relevant sensor data via the communication interface 160 to another transportation vehicle or to a central computer 320 or elsewhere, the gateway 30 is provided. This is connected to the different bus systems 100, 102, 104 and 106. The gateway 30 is adapted to convert the data it receives via the one bus to the transmission format of the other bus so that it can be distributed in the packets specified there. For the forwarding of this data to the outside, i.e., to another transportation vehicle or to central computer 320, the on-board communication module 160 is equipped with the communication interface to receive these data packets and, in turn, to convert them into the transmission format of the correspondingly used mobile radio standard. The gateway 30 takes all the necessary format conversions if data are to be exchanged between the different bus systems inside the transportation vehicle if required.

It is expressively mentioned that the transportation vehicles 1001 to 1010 depicted in FIGS. 1 to 3 also may be equipped with such kind of board electronics system as shown in FIG. 5. It is not needed that the transportation vehicles 1001 to 1010 will have the full autonomous driving capability as defined in level 5 of the SAE autonomous driving table, corresponding to full autonomous driving capability. It will be sufficient that the transportation vehicles 1001 to 1010 are equipped with a driver assistance system for parking.

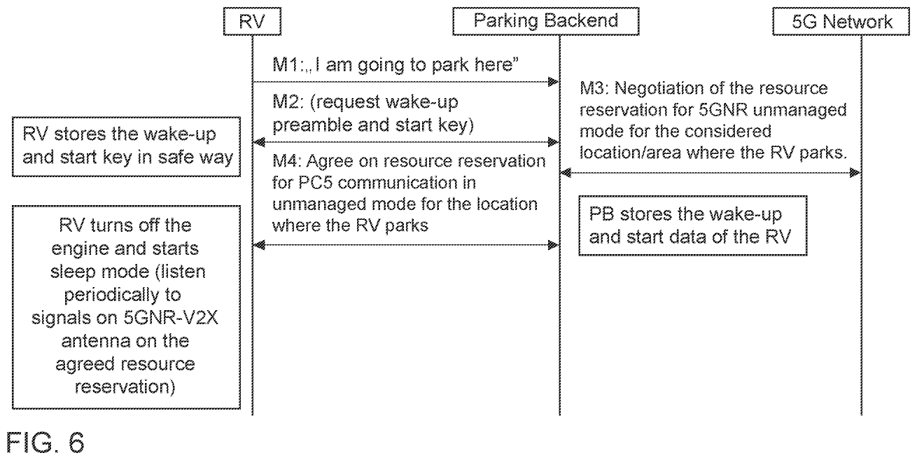

In the following, an exemplary embodiment shall be described in more detail with reference to FIGS. 6 to FIG. 10.

FIG. 6 depicts the message exchange between one of the transportation vehicles 1001 to 1006 and a parking backend server when they have reached the parking position and stop operation of the engine or the electric motor. The parking backend server may be a server which is close to the parking lot or to the public road where parking is allowed in dedicated parking places or at the side of the road. Such parking backend server might be located at a road side unit such as the road side unit 310 depicted in FIG. 4. An exemplary embodiment is the localization of the parking backend server at the base station nearby the parking area, see reference number 220.

In FIG. 6, the parking transportation vehicle is referenced with reference sign RV corresponding to “remote vehicle”. In the depicted parking situation of FIG. 1 this might be one or more or all of the transportation vehicles 1001 to 1006. It is considered that a transportation vehicle 1003 is the remote vehicle RV. When transportation vehicle 1003 has arrived at its parking place, and the driver was leaving the car, the on-board communication module 160 transmits a message to the parking backend server 220 via Uu interface that it intends to park and to turn of the motor/engine in message M1. What happens next is a message exchange M2 between remote vehicle RV and parking backend server 220 where remote vehicle RV requests a wakeup preamble and a start key command from parking backend server 220 and the parking backend server 220 returns these two information items individualized for the requesting remote vehicle RV. The function of these information item are: With the reception of the negotiated wakeup preamble the on-board communication module 160 will be switched on from sleep mode to normal mode. With the start key information item the board electronics will be switched to power-on mode, and the engine will be started. Both information items are parts of a message to which the remote vehicle RV needs to react. When the remote vehicle RV is in park mode, the board electronics system is in power off or sleep mode. The on-board communication module 160 will be put in sleep mode. The sleep mode will be used to save energy. However, in sleep mode the on-board communication module 160 needs to monitor if a wake-up message has arrived. To implement a very energy efficient monitoring function it will also be negotiated in a further message exchange M3 to which communication resources remote vehicle RV should listen in sleep mode on the PC5 interface. This will be negotiated with the network operator to which the remote vehicle RV has subscribed. In at least one exemplary embodiment the parking backend server 220 gets the resource reservation proposal from base station 210. In another exemplary embodiment the base station 210 forwards the request to EPC 200 where it will be routed to the Internet 300 and finally to a backend server 320 of the network operator. Once the proposal is received, the parking backend server 220 forwards the resource reservation information to remote vehicle RV via Uu-interface with message exchange M4. The parking backend server 220 stores the wake-up preamble and start key from message exchange M2 in memory. The on-board communication module 160 stores the wake-up preamble and start key from message exchange M2 in its memory. And so it does with the resource reservation information from message exchange M4. This way it will be agreed on which resource block or blocks the remote vehicle RV should listen in sleep mode on the PC5 interface. The effect of this type of resource reservation is that there is no need for a broadband reception operation in the on-board communication module 160 and higher energy consumption for monitoring all communication resources on the PC5 interface all the times in normal operation mode. On one hand the effect of a reduced energy consumption is due to the fact that the on-board communication module 160 enters sleep mode, where it only sporadically listens to the signals received by the antenna.

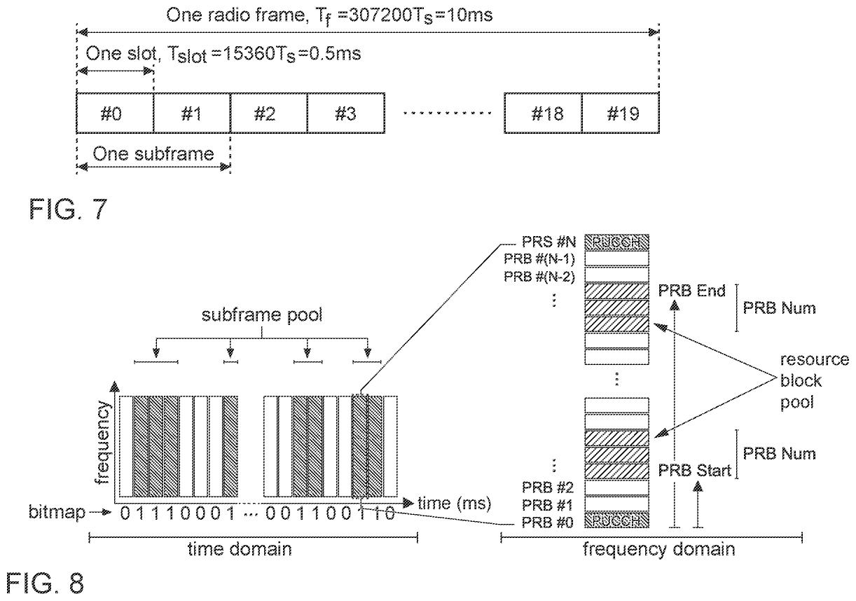

To further explain this, it will to be described how the data communication via PC5 interface works. PC5 communication is sometimes called direct communication and often also referred to be sidelink communication. Central to sidelink transmission and reception is the concept of so-called resource pools (RP). A resource pool is a set of transmission resources assigned to a sidelink operation. It consists of the subframes and the resource blocks transferred in the subframe. FIG. 7 shows the participation of a radio frame in LTE communication via Uu interface in subframes. Each sub-frame consists of two time slots with a duration of 0.5 ms each. FIG. 8 then shows a collection of subframes which are pooled. In each subframe a plurality of resource blocks can be selected to belong the resource pool. This way a pretty small resource pool may be reserved for the parking assistance wake-up communication. So, if e.g., only one sub-frame will be reserved with a few resource blocks this resource pool has a narrow bandwidth assigned, since in frequency domain a resource block occupies just 180 kHz of bandwidth in the PC5 spectrum. The receiver in the on-board communication module 160 which is put in sleep mode then does not need to scan the whole bandwidth of the PC5 communication. It will just evaluate the signals in the 180 kHz bandwidth assigned to the reserved resource pool.

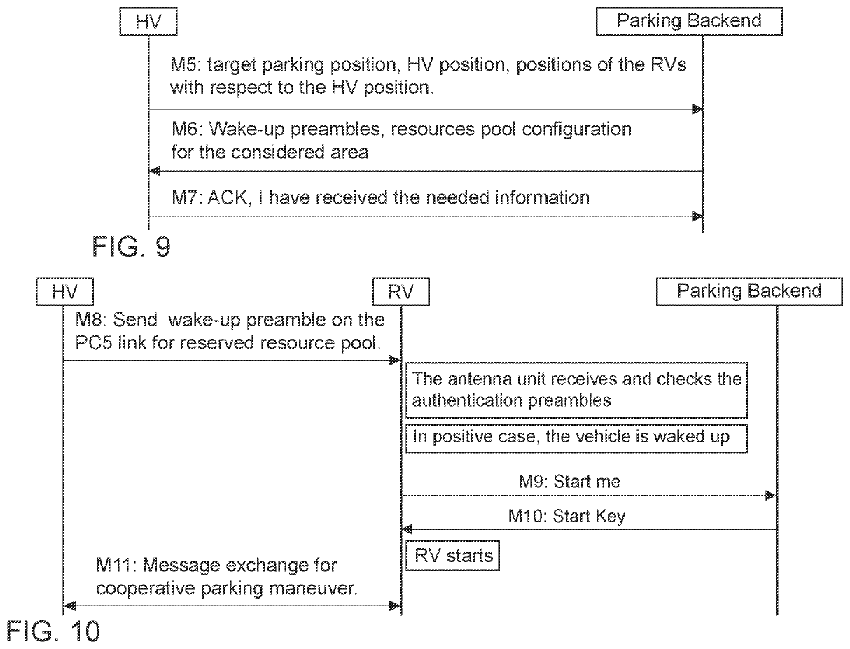

FIG. 9 schematically illustrates the message exchange when an arriving transportation vehicle 1010 arrives at the parking place depicted in FIG. 1 but needs to start a cooperative parking maneuver to enter it. With message M5 the arriving transportation vehicle HV indicates that it wants to park. It will identify its position derived with the help of its navigation system 130 and the estimated positions of the parking transportation vehicles 1001 to 1004. Position estimation can be performed with the help of the surrounding observation sensors 150, 151, 182 and 184 as explained in connection FIG. 5. In message M5 or a further message it will also be indicated that arriving transportation vehicle HV requests the wake-up preamble, start key and resource pool configuration for each of the transportation vehicles 1001 to 1004. The message is sent via Uu-interface to parking backend 220. Parking backend 220 returns back the requested information in message transfer M6. Arriving transportation vehicle HV acknowledges receipt of this information in message M7 to parking backend server 220.

FIG. 10 then shows how the parking transportation vehicles 1002 and 1003 will be woken-up to perform the cooperative parking maneuver on request of the arriving transportation vehicle 1010. With message transfer M8 the arriving transportation vehicle sends a wake-up message to parking transportation vehicle 1003 on the PC5 link but just with the subframe or set of subframes according to the resource pool that is reserved for this wake-up message. The parking transportation vehicle 1003 is listening to this resource pool sporadically. The arriving transportation vehicle 1010 will repeat the message that often that it is made sure that the parking transportation vehicle 1003 receives this information in it sleep mode monitoring cycle.

One's parking transportation vehicle 1003 has received the message M8, the on-board communication module 160 will leave its sleep mode and it will check the authentication of the information received in the wake-up message and if authenticated the on-board communication module 160 will send a start request message to the parking backend server 220 with message M9. Of course the parking transportation vehicle 1003 will be identified in the message with the help of the estimated position information. Parking backend server 220 then transfers the start key information in a message M10 to the parking transportation vehicle 1003. Once the parking transportation vehicle 1003 has received the start key and has authenticated it, it will power-up its board electronics system. What happens after that is the message exchange for the cooperative parking maneuver, where arriving transportation vehicle 1010 will ask the parking transportation vehicle 1003 to drive back a certain distance, e.g., 80 cm. Once that is done, the arriving transportation vehicle 1010 will send a wake-up message to the parking transportation vehicle 1002 and also ask it to drive back such that finally the gap between parking transportation vehicle 1001 and 1002 is increased such that arriving transportation vehicle 1010 can enter it properly. Once each cooperative parking maneuver is finished, the parking transportation vehicle receives an end of cooperative parking maneuver message and goes back to sleep mode.

In further exemplary embodiments, a computer program comprises program code, which, when executed by a computing system, causes the computing system to perform the method for starting a parking transportation vehicle located on a parking position in park mode to perform a cooperative parking maneuver. The computer programs will be executed in a processing unit of the on-board-communication module 160.

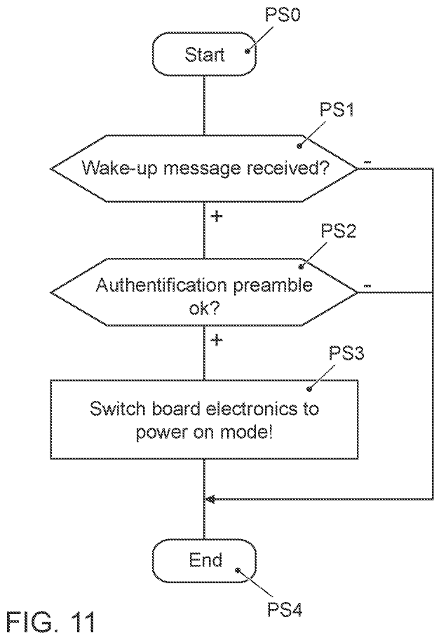

A flow chart for a computer program which runs on a processor of the on-board communication unit 160 is shown in FIG. 11. This program will be executed each time when the on-board communication unit 160 listens periodically to wake-up messages. The program starts in operation at PS0. In operation at PS1 the on-board communication unit 160 listens to a wake-up message on the reserved resources. If no wake-up message is received during the listening phase, the program ends in operation at PS4. If a wake-up message has been received, the on-board communication unit 160 checks the authentication preamble received in the wake-up message. This can be done by calculating hash values by utilizing pre-installed certificates. If the authentication test is positive, the board electronics of the parking transportation vehicle will be switched to power-on mode. If the authentication test is negative, the program ends in operation at PS4.

Likewise in another exemplary embodiment a computer program comprises program code, which, when executed by a computing system, causes the computing system to perform a method for requesting a cooperative parking maneuver by an arriving transportation vehicle which arrives at a location of a parking transportation vehicle intending to perform the cooperative parking maneuver with the parking transportation vehicle. The operations of these two computer programs are disclosed in the drawings of FIGS. 6, 9 and 10. The computer programs will be executed in a processing unit of the on-board-communication module 160.

It is to be understood that the proposed method and apparatus may be implemented in various forms of hardware, software, firmware, special purpose processors, or a combination thereof. Special purpose processors may include application specific integrated circuits (ASICs), reduced instruction set computers (RISCs) and/or field programmable gate arrays (FPGAs). Optionally, the proposed method and apparatus is implemented as a combination of hardware and software. Moreover, the software may be implemented as an application program tangibly embodied on a program storage device. The application program may be uploaded to and executed by a machine comprising any suitable architecture. Optionally, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

The disclosure is not restricted to the exemplary embodiments described here. There is scope for many different adaptations and developments, which are also considered to belong to the disclosure.

### LIST OF REFERENCE NUMERALS

10 Transportation vehicle

20 Touch screen

30 Gateway

40 Computing device

50 Operation element unit

60 Memory unit

70 Data line to display unit

80 Data line to memory unit

90 Data line to operation element unit

100 1^{st} Data bus

102 2^{nd} Data bus

104 3^{rd} Data bus

106 4^{th} Data bus

110 Multifunction display

120 Telephone

130 Navigation system

140 Radio

150 Front camera

151 Back, Left, Right camera

160 On-Board Communication Unit

172 Engine control device

174 ESP control device

176 Transmission control device

182 RADAR sensor

184 Automatic driving control device

186 LIDAR sensor

190 On-Board diagnosis interface

200 Evolved packet core

210 Base station

220 Parking backend server

300 Internet

310 Road side unit

320 Backend server

M1-M11 Different messages

Uu V2N communication link

PC5 V2V communication link

S1 EPC communication link

PS0-PS4 Different program operations of wake-up procedure

1. A method for starting a parking transportation vehicle located on a parking position in park mode to perform a cooperative parking maneuver, the parking transportation vehicle being equipped with an on-board communication module, the method comprising:
registering, with a message exchange, wake-up information in a parking backend server in response to the parking transportation vehicle being put in park mode, the wake-up information including information about communication resources to be used for sending a wake-up message to the parking transportation vehicle and for identifying the wake-up message;
listening to the registered communication resources during park mode and leaving park mode and switching to a normal operation mode in response to receiving the wake-up message from an arriving transportation vehicle;
sending a starting request message to the parking backend server;
receiving a starting message from the parking backend server; and
directly or indirectly starting the engine or motor for performing the cooperative parking maneuver.

2. The method of claim 1, wherein the listening to the registered communication resources during park mode comprises sporadically listening to the registered communication resources during park mode, wherein the sporadically listening to the registered communication resources during park mode comprises listening to the registered communication resources periodically in an interval which is longer than an interval with which the arriving transportation vehicle repeats its wake-up message.

3. The method of claim 1, wherein the registered wake-up information comprises an authentication preamble which is used in the wake-up message which is sent by the arriving transportation vehicle to identify the wake-up message.

4. The method of claim 1, wherein the registered wake-up information further comprises the resource pool configuration to which the parking transportation vehicle listens in park mode.

5. The method of claim 3, wherein the checking the authentication preamble is executed as part of the wakeup process before waking up the whole board electronics of the transportation vehicle and wherein the waking up the transportation vehicles board electronics is suppressed in response to the preamble check resulting in the finding that the authentication preamble does not match the registered authentication preamble.

6. The method of claim 1, wherein the registered wake-up information further comprises a start key which the parking backend server sends in the starting message, to start the engine or motor for performing the cooperative parking maneuver.

7. The method of claim 1, wherein the messages for registering wake-up information, and the starting request message are sent as an LTE or 5G Uu-link communication message and wherein the wake-up message is sent as an LTE or 5G direct-link communication message.

8. A non-transitory computer readable medium that stores a computer program comprising instructions, which, when executed by a computer, cause the computer to perform the method for starting a parking transportation vehicle located on a parking position in park mode to perform a cooperative parking maneuver, the parking transportation vehicle being equipped with an on-board communication module, the method comprising:
registering, with a message exchange, wake-up information in a parking backend server in response to the parking transportation vehicle being put in park mode, the wake-up information including information about communication resources to be used for sending a wake-up message to the parking transportation vehicle and for identifying the wake-up message;
listening to the registered communication resources during park mode and leaving park mode and switching to a normal operation mode in response to receiving the wake-up message from an arriving transportation vehicle;
sending a starting request message to the parking backend server;
receiving a starting message from the parking backend server; and
directly or indirectly starting the engine or motor for performing the cooperative parking maneuver.

9. A method for requesting a cooperative parking maneuver by an arriving transportation vehicle which arrives at a location of a parking transportation vehicle intending to perform the cooperative parking maneuver with the parking transportation vehicle, the method comprising:
sending a cooperative parking intention message to a parking backend server that includes at least an estimated position of the parking transportation vehicle and a request for wake-up information for the parking transportation vehicle.

10. The method of claim 9, wherein the cooperative parking intention message further comprises the position of the arriving transportation vehicle and wherein the estimated position of the parking transportation vehicle is formatted as a position relative to the position of the arriving transportation vehicle.

11. The method of claim 9, wherein the arriving transportation vehicle is receiving the requested wake-up information from the parking backend server in one or more response messages to the cooperative parking intention message, the response message including an authentication preamble which needs to be used in a wake-up message sent by the arriving transportation vehicle to identify the wake-up message.

12. The method of claim 11, wherein the one or more response message further comprises the resource pool configuration to be used for sending the wake-up message to the parking transportation vehicle to which the parking transportation vehicle is listening in park mode.

13. The method of claim 11, wherein the arriving transportation vehicle is repeatedly sending the wake-up message to the parking transportation vehicle after having received the requested wake-up information from the parking backend server in one or more response messages.

14. The method of claim 9, wherein the cooperative parking intention message and the one or more response message to the cooperative parking intention message, are sent as an LTE or 5G Uu-link communication message and wherein the wake-up message is sent as an LTE or 5G direct-link communication message.

15. A non-transitory computer readable medium that stores a computer program comprising instructions, which, when executed by a computer, cause the computer to perform the method for requesting a cooperative parking maneuver by an arriving transportation vehicle which arrives at a location of a parking transportation vehicle intending to perform the cooperative parking maneuver with the parking transportation vehicle, the method comprising:
sending a cooperative parking intention message to a parking backend server that includes at least an estimated position of the parking transportation vehicle and a request for wake-up information for the parking transportation vehicle.
